(19) United States
(12) Patent Application Publication
(10) Pub. No.: US 2017/0188305 A1
(43) Pub. Date: Jun. 29, 2017

(54) WIRELESS COMMUNICATION DEVICE

(71) Applicant: KABUSHIKI KAISHA TOSHIBA, Minato-ku (JP)

(72) Inventors: Hiroki KUDO, Kawasaki (JP); Ren SAKATA, Yokohama (JP); Yuji TOHZAKA, Kawasaki (JP)

(73) Assignee: KABUSHIKI KAISHA TOSHIBA, Minato-ku (JP)

(21) Appl. No.: 15/391,512

(22) Filed: Dec. 27, 2016

(30) Foreign Application Priority Data
Dec. 28, 2015 (JP) 2015-257228
Oct. 27, 2016 (JP) 2016-211062

(51) Int. Cl. H04W 52/02; H04W 56/00; H04W 72/04

(52) U.S. Cl. CPC H04W 52/0235; H04W 72/0446; H04W 56/0055; H04W 56/004

(57) ABSTRACT

A wireless communication device according to an embodiment has an interface and a sleep controller. The interface transmits and receives a wireless signal. The sleep controller sets a sleep period equal to or shorter than a predetermined interrupt period when a first period from a current time to a start timing of a next one of the task is longer than the interrupt period.

### CROSS REFERENCE TO RELATED APPLICATIONS

This application is based upon and claims the benefit of priority from the prior Japanese Patent Applications No. 2015-257228, filed on Dec. 28, 2015, and No. 2016-211062, filed on Oct. 27, 2016, the entire contents of which are incorporated herein by reference.

### FIELD

Embodiments described herein relate to a wireless communication device.

### BACKGROUND

As a method of power saving for a wireless communication device, there have been known methods of repeating the wake-up and the sleep of a wireless communication device intermittently. However, conventional wireless communication devices have fixed periods during which the wireless communication devices sleep. For this reason, in a wireless communication device having a simple hardware configuration that limits a settable sleep period, an actual sleep period is too long or too short due to a limit value of sleep period. That is, it is difficult to set an appropriate sleep period in accordance with the limit value of sleep period. As a result, a sufficient reduction of power consumption of the wireless communication device cannot be achieved.

### BRIEF DESCRIPTION OF THE DRAWINGS

FIG. 1 is a diagram illustrating an example of a functional configuration of a wireless communication device in a first embodiment;

FIG. 2 is a diagram illustrating an example of a task table;

FIG. 3A is a flowchart illustrating an example of the operation of the wireless communication device in the first embodiment;

FIG. 3B is a diagram for explaining a magnitude relationship among a first period T₁, an interrupt period Th and a third period T₃ when the first period T₁ is equal to or shorter than the interrupt period Th;

FIG. 3C is a diagram for explaining a magnitude relationship among a first period T₁, an interrupt period Th, an second period T₂ and an third period T₃ when the first period T₁ is longer than the interrupt period Th; FIG. 4 is a diagram illustrating an example of a method of assigning slot numbers;

FIG. 5 is a diagram illustrating an example of the task table;

FIG. 6A is a flowchart illustrating an example of the operation of the wireless communication device in a second embodiment;

FIG. 6B is a diagram for explaining a magnitude relationship among a first period S₁, an interrupt period Sh and a third period S₃ when the first period S₁ is equal to or shorter than the interrupt period Sh;

FIG. 6C is a diagram for explaining a magnitude relationship among a first period S₁, an interrupt period Sh, a second period S₂ and a third period S₃ when the first period S₁ is longer than the interrupt period Sh;

FIG. 7 is a diagram illustrating an example of a functional configuration of a wireless communication device in a third embodiment;

FIG. 8 is a flowchart illustrating an example of the operation of the wireless communication device in the third embodiment;

FIG. 9 is a flowchart illustrating an example of the operation of the wireless communication device in the third embodiment;

FIG. 10 is a flowchart illustrating an example of the operation of a wireless communication device in a fourth embodiment;

FIG. 11 is a flowchart illustrating an example of the operation of the wireless communication device in the fourth embodiment; and

FIG. 12 is a hardware block diagram when a main processor and a sleep controller are constituted by a microcomputer.

### DETAILED DESCRIPTION

A wireless communication device according to an embodiment has an interface and a sleep controller. The interface transmits and receives a wireless signal. The sleep controller sets a sleep period equal to or shorter than a predetermined interrupt period when a first period from a current time to a start timing of next task is longer than the interrupt period.

In a conventional wireless communication device, when simple hardware, especially like a microcomputer, is used, its power consumption can be minimized by setting a sleep period longer, and if it is driven by, for example, a battery, it results in extending its battery life. In addition, if a power supply to an analog processing circuit like an amplifier for a wireless communication is stopped, the power consumption is more reduced and the battery life is more extended. However, in this case, since the power supply to its hardware for transmitting and receiving the wireless signal is stopped in a sleeping state, the wireless signal cannot be received. Therefore, in order to perform the wireless communication, a time synchronization between wireless communication devices is required. More specifically, a wireless communication device transmitting the wireless signal needs to transmit the wireless signal at a timing when a wireless communication device of a receiver is in a wake-up state.

One of the measures to decide a timing for transmission and reception is the time division communication. In the time division communication, time-divided periods are assigned to wireless communication devices, and communication periods are previously shared by wireless communication devices to be communicated. Regarding the communication periods, various ways can be applied. For example, it is previously decided based on ID, the communication period is shared through the wireless communication prior to the transmission, or the like.

Although it is possible to synchronize the timing of the transmission and reception in the time-divided communication, possible sleep period is limited and it is difficult to set a long sleep period if the simple hardware like the microcomputer and so on is used. Alternatively, even when the long sleep period can be set, there is a problem that an accuracy of the time synchronization among wireless communication devices deteriorates due to a low settable resolution.

Hereafter, the detailed embodiments will be described with reference to the drawings.

### First Embodiment

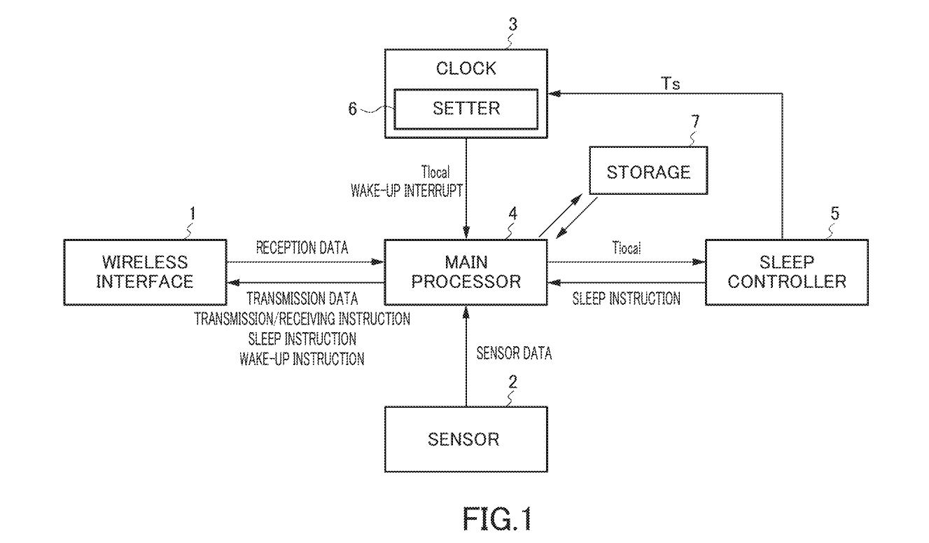

A wireless communication device in a first embodiment will be described with reference to FIG. 1 to FIG. 3C. The wireless communication device in the present embodiment is used as each node in, for example, a mesh or tree wireless network. Hereafter, the description will be made assuming the case where a wireless communication device is applied to a sensor network, but an applicable wireless network is not limited to the sensor network.

Firstly, the configuration of the wireless communication device in the present embodiment will be described. FIG. 1 is a diagram illustrating an example of a functional configuration of the wireless communication device in the present embodiment. The wireless communication device in FIG. 1 includes a wireless interface 1, a sensor 2, a clock 3, a main processor 4, a sleep controller 5, and a setter 6.

The wireless interface 1 transmits and receives wireless signals. The wireless interface 1 subjects a received wireless signal to predetermined signal processing such as downconversion to acquire reception data contained in the wireless signal. The wireless interface 1 inputs the acquired reception data into the main processor 4. In addition, the wireless interface 1 subjects transmission data input from the main processor 4 to predetermined signal processing such as upconversion to generate a wireless signal containing the transmission data, and transmits the generated wireless signal to the outside. The transmission and reception of a wireless signal performed by the wireless interface 1 are controlled by the main processor 4.

The wireless interface 1 has a wake-up state and a sleeping state, as operation states. The wake-up state of the wireless interface 1 is a state in which the wireless interface 1 is able to transmit and receive wireless signals. The wake-up state corresponds to, for example, a state in which power has been turned on. The sleeping state of the wireless interface 1 is a state in which the wireless interface 1 is unable to transmit and receive wireless signals. The sleeping state corresponds to, for example, a state in which the power has been turned off. The wireless interface 1 in the sleeping state consumes significantly less power than that in the wake-up state.

Hereafter, in the wireless interface 1 or the like, the transition of the operation state from the wake-up state to the will be referred to as sleep. In addition, a process of causing the transition from the wake-up state to the sleeping state will be referred to as a sleep process.

Similarly, in the wireless interface 1 or the like, the transition of the operation state from the sleeping state to the wake-up state will be referred to as wake-up. In addition, a process of causing the transition from the sleeping state to the wake-up state will be referred to as a wake-up process.

The wireless interface 1 is constituted by a radio frequency (RF) circuit. The RF circuit is an analog processing circuit that includes an antenna, a mixer, an amplifier, a filter, an oscillator, and the like. The wireless interface 1 may be constituted by a one-chip integration circuit (IC) or may be constituted by two or more ICs. In addition, the wireless interface 1 may include an analog-to-digital converter (ADC) or a digital-to-analog converter (DAC).

The sensor 2 measures any physical quantity such as temperature, pressure, humidity, voltage, current, and electric power. The sensor 2 inputs sensor data acquired through the measurement into the main processor 4. The sensor 2 is constituted by one or more sensing devices that correspond to measurement objects.

Note that, in the present embodiment, the wireless communication device can have a configuration that does not include the sensor 2. In this case, the wireless communication device may be connected to an exterior sensor and acquire the sensor data from the connected exterior sensor.

The clock 3 generates a clock signal at a predetermined cycle independent of the power state (on or off) or operation state (sleeping state or wake-up state) of the wireless communication device. The clock 3 has a counting function of counting a current time Tlocal based on the clock signal. The clock 3 inputs the current time Tlocal into the main processor 4.

In addition, in the example illustrated in FIG. 1, the clock 3 includes the setter 6. The setter 6 has a timer interrupt function. The timer interrupt function is a function of outputting an interrupt request at an interrupt time point Tint that is set in advance. In the present embodiment, the setter 6 outputs a wake-up interrupt request at the interrupt time point Tint having been set, the wake-up interrupt request causing the main processor 4 to wake up. The wake-up interrupt request output by the setter 6 is input into the main processor 4.

The setter 6 has an interrupt period Th being a period within which the interrupt time point Tint can be set. The interrupt time point Tint is a time point to generate an interrupt. The interrupt is, for example, a signal to cause the wireless interface 1 and the main processor 4 being in the sleeping state to wake up so as to cause the wireless interface 1 to execute a task.

The setter 6 can set, as the interrupt time point Tint, any time point from the current time Tlocal to Tlocal+Th (Tlocal<Tint≦Tlocal+Th). Conversely, the setter 6 cannot set a time point after the current time Tlocal+Th, as the interrupt time point Tint. The interrupt period Th depends on the hardware configuration of the setter 6. In general, the simpler the hardware configuration of the setter 6 is, the shorter the interrupt period Th is. A method of setting the interrupt time point Tint will be described later in detail.

The clock 3 is constituted by a clock generation circuit including an oscillator circuit and the like. As the clock 3 having the counting function and the timer interrupt function (the setter 6), for example, a real time clock can be used.

The main processor 4 manages tasks (processes) to be executed the device. In addition, the main processor 4 controls the wireless interface 1 to execute a task. The term “task” herein includes a sensor acquisition task to acquire sensor data from the sensor 2, a transmission task to cause the wireless interface 1 to transmit a wireless signal, and a reception task to cause the wireless interface 1 to receive a wireless signal. For each task, the main processor 4 remembers a kind, an execution timing, and an execution period, in advance.

In order to manage tasks, the main processor 4 remembers a task table in which information on the tasks registered to the device is stored. In the task table, each task is associated with the kind, the execution timing, and the execution period of the task.

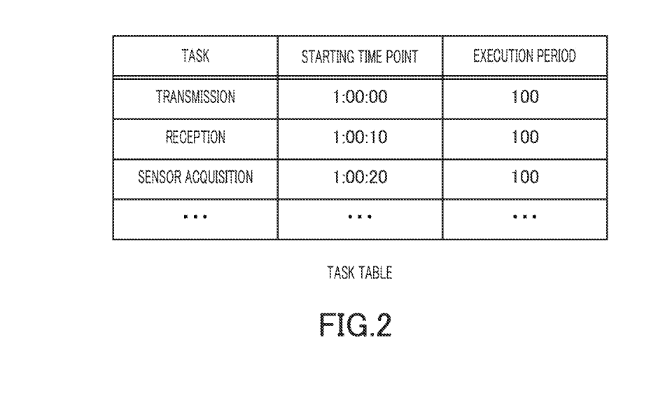

FIG. 2 is a diagram illustrating an example of a task table in the present embodiment. In the example illustrated in FIG. 2, each record corresponds to each task. In each record, the kind, the starting time point (the execution timing), and the execution period of the task are stored. For example, the record in the first row indicates a transmission task to be executed for 100 msec from 1:00:00. Hereafter, it is assumed in the present embodiment that the execution timing is managed in terms of time points, and the execution period is managed in terms of time periods, as the task table illustrated in FIG. 2.

The main processor 4 refers to such a task table to determinate which task the device needs to execute at the current time Tlocal. When a task that needs to be executed is present at the current time Tlocal, the main processor 4 executes the task.

To execute the sensor acquisition task, the main processor 4 acquires sensor data from the sensor 2 and stores the acquired sensor data.

To execute the transmission task, the main processor 4 generates transmission data. The transmission data contains, for example, sensor data, basic information on the device (e.g., an identifier (ID)), address information, and the like, which are stored in the main processor 4.

Thereafter, the main processor 4 inputs transmission data and a transmitting instruction into the wireless interface 1. Upon receiving the transmitting instruction, the wireless interface 1 transmits a wireless signal corresponding to the transmission data.

To execute the reception task, the main processor 4 inputs a receiving instruction into the wireless interface 1. Upon receiving the receiving instruction, the wireless interface 1 receives a wireless signal and inputs reception data contained in the received wireless signal into the main processor 4. Upon receiving the reception data, the main processor 4 performs a predetermined process such as a confirmation of address information contained in the reception data.

In addition, the main processor 4 controls the operation state of the wireless interface 1. Specifically, the main processor 4 inputs a sleep instruction into the wireless interface 1 to cause the wireless interface 1 to settle into sleep. In addition, the main processor 4 inputs a wake-up instruction into the wireless interface 1 to cause the wireless interface 1 to wake up.

In addition, the main processor 4 has a wake-up state and a sleeping state, as operation states. The wake-up state of the main processor 4 is a state in which the main processor 4 is able to execute a task. The wake-up state corresponds to, for example, a state in which power has been turned on. The sleeping state of the main processor 4 is a state in which the main processor 4 is unable to execute any task. The sleeping state corresponds to, for example, a state in which the power has been turned off. The main processor 4 in the sleeping state consumes significantly less power than that in the wake-up state.

The main processor 4 is constituted by, for example, a processor including a baseband circuit. As the processor, for example, a general-purpose processor, a central processing unit (CPU), a microprocessor, a digital signal processor (DSP), a controller, a microcontroller, a state machine, an application-specific integrated circuit (ASIC), a field programmable gate array (FPGA), a programmable logic device (PLD), and a combination thereof can be used. The main processor 4 may be constituted by a one-chip IC or may be constituted by two or more ICs.

Note that the main processor 4 in the present embodiment may have a counting function of counting the current time Tlocal. By inputting a clock signal from the clock 3 into the main processor 4, the main processor 4 can count the current time Tlocal. In the case where the main processor 4 has the counting function, the clock 3 does not need to have the counting function. In this case, the counting function of the main processor 4 works even when the main processor 4 is in the sleeping state.

In addition, the main processor 4 in the present embodiment may have a timer interrupt function. That is, in addition to the part to execute a task, the main processor 4 may include the setter 6. In the case where the main processor 4 has the timer interrupt function (the setter 6), the clock 3 does not need to have the timer interrupt function (the setter 6). The timer interrupt function of the main processor 4 works even when the main processor 4 is in the sleeping state.

The sleep controller 5 controls the operation state of the main processor 4. Specifically, the sleep controller 5 inputs a sleep instruction into the main processor 4 to cause the main processor 4 to settle into sleep.

In addition, the sleep controller 5 sets a sleep period Ts based on the current time Tlocal and a starting time point (execution timing) of the next task and notifies the sleep period Ts to the setter 6. The sleep period Ts is a period during which the wireless interface 1 and the main processor 4 sleep. The sleep period will be described later in detail.

When the sleep period Ts is notified from the sleep controller 5, the setter 6 sets a wake-up interrupt. An interrupt time point Tint, at which this wake-up interrupt is processed, is after a lapse of the sleep period Ts from the current time Tlocal (Tint=Tlocal+Ts).

In the present embodiment, upon receiving the sleep instruction from the sleep controller 5, the main processor 4 causes the wireless interface 1 to settle into sleep. As a consequence, the sleep controller 5 controls the operation states of both of the wireless interface 1 and the main processor 4. In this way, the sleep controller 5 may directly control the operation states of objects to be controlled, or control them via other units like the main processor 4, the clock 3 and so on.

The sleep controller 5 is constituted by, for example, a processor. Available processors have already been described previously. The sleep controller 5 may be constituted by a one-chip IC or may be constituted by two or more ICs.

Furthermore, the wireless communication device may have a storage 7. The storage 7 stores, for example, received data, transmitted data and senor data. In addition, the storage 7 may store the information on sleep instructions and wake-up interrupts. For example, the data stored in the storage 7 is input from the main processor 4 or output to the main processor 4.

The above-described wireless interface 1, clock 3, main processor 4, sleep controller 5, and setter 6 may be configured by different ICs, or two or more of them may be configured by an identical IC.

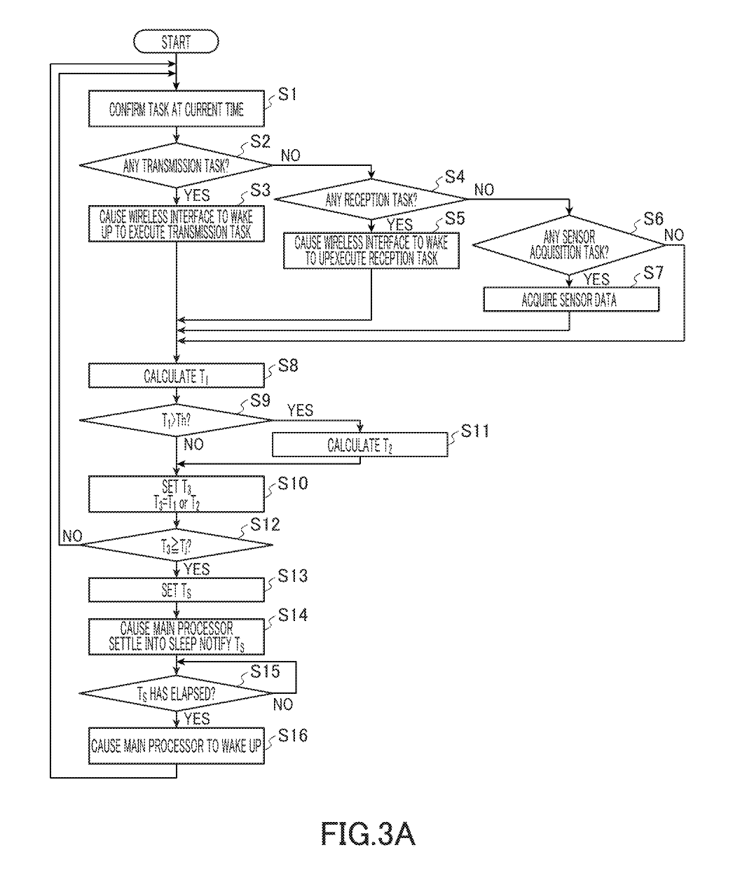

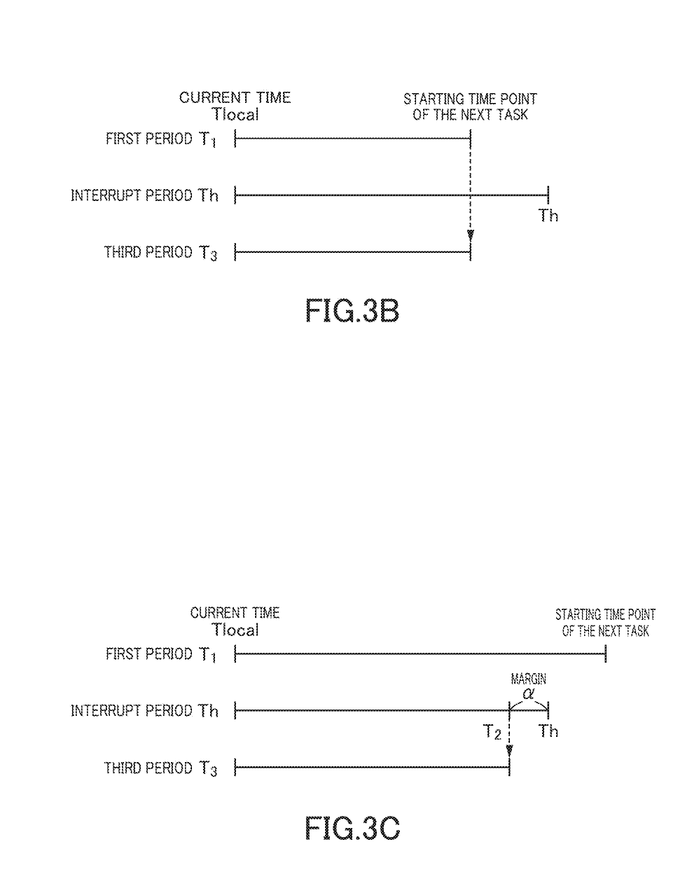

Next, the operation of the wireless communication device in the present embodiment will be described. FIG. 3A is a flowchart illustrating an example of the operation of the wireless communication device in the present embodiment. Hereafter, it is assumed that, at a starting time point of the operation, the wireless interface 1 is sleeping, and the main processor 4 has woken up.

Firstly, the main processor 4 refers to the task table to confirm whether or not a task that needs to be executed at the current time Tlocal is present (step S1). Specifically, the main processor 4 compares the current time Tlocal input from the clock 3 with the starting time point of each task. Then, the main processor 4 grasp a task having a starting time point that matches the current time Tlocal, or a task having a starting time point that is earlier than the current time Tlocal and having an execution period within which the current time Tlocal falls, as a task that needs to be executed at the current time Tlocal.

When a transmission task is present as the task that needs to be executed at the current time Tlocal (YES in step S2), the main processor 4 inputs a wake-up instruction into the wireless interface 1 to cause the wireless interface 1 to wake up. Then, the main processor 4 executes the transmission task during the execution period (step S3). Thereafter, the processing of the flowchart proceeds to step S8.

When a reception task is present as the task that needs to be executed at the current time Tlocal (YES in step S4), the main processor 4 inputs a wake-up instruction into the wireless interface 1 to cause the wireless interface 1 to wake up. Then, the main processor 4 executes the reception task during the execution period (step S5). Thereafter, the processing of the flowchart proceeds to step S8.

When a sensor acquisition task is present as the task that needs to be executed at the current time Tlocal (YES in step S6), the main processor 4 executes the sensor acquisition task during the execution period. That is, the main processor 4 acquires sensor data from the sensor 2 and stores the acquired sensor data (step S7). Thereafter, the processing of the flowchart proceeds to step S8.

When there is no task that needs to be executed at the current time Tlocal (NO in step S6), the processing of the flowchart proceeds to step S8.

In step S8, the sleep controller 5 calculates a first period T₁. The first period T₁ corresponds to a period from the current time Tlocal up to the starting time point of the next task. The next task is a task having the earliest starting time point of tasks to be executed after the current time Tlocal.

The sleep controller 5 acquires, from the main control unit 4, the current time Tlocal and the starting time point of each task that is stored in the task table, and calculates the first period T₁ by the following formula.

[Expression 1]

T₁=min(Time[k]−Tlocal) (1)

In Formula (1), Time[k] is the starting time point of each task. An index k represents a number that is assigned to each task that has a starting time point after the current time Tlocal (Time[k]>Tlocal). When the total number of the tasks stored in the task table is N, 0≦k<N is satisfied.

Next, the sleep controller 5 compares the first period T₁ with an interrupt period Th (step S9). When the first period T₁ is equal to or shorter than the interrupt period Th (T₁≦Th) (NO in step S9), the sleep controller 5 sets the first period T₁ to a third period T₃ (step S10). That is, T₃=T₁≦Th is satisfied. A magnitude relationship among the first period T₁, the interrupt period Th and the third period T₃ is shown in FIG. 3B.

On the other hand, when the first period T₁ is longer than the interrupt period Th (T₁>Th) (YES in step S9), the sleep controller 5 calculates a second period T₂ based on the interrupt period Th (step S11). The second period T₂ is a period that is equal to or shorter than the interrupt period Th and is calculated by, for example, the following formula.

[Expression 2]

T₂=Th−α (2)

In Formula (2), α (0≦α≦Th) is a margin that is set in advance. Subtracting the margin α from the interrupt period Th makes the second period T₂ equal to or shorter than the interrupt period Th. Thereafter, the sleep controller 5 sets the second period T₂ to the third period T₃ (step S10).

That is, T₃=T₂≦Th is satisfied. A magnitude relationship among the first period T₁, the interrupt period Th, the second period T₂ and the third period T₃ is shown in FIG. 3C.

As seen from the above description, in the wireless communication device in the present embodiment, the third period T₃ is set to be equal to or shorter than the interrupt period Th in every case.

Subsequently, the sleep controller 5 determines whether or not the sleep process and the wake-up process can be performed in the wireless interface 1 and the main processor 4 during the third period T₃. To this end, the sleep controller 5 first refers to the task table to grasp the kind of the next task. Next, the sleep controller 5 calculates a determination period Tj based on a current operation state of the wireless interface 1 and the kind of the next task. The determination period Tj is a period that is necessary to perform the sleep process and the wake-up process on the wireless interface 1 and the main processor 4.

Then, the sleep controller 5 compares the third period T₃ with the determination period Tj (step S12). When the third period T₃ is equal to or longer than the determination period Tj (T₃≧Tj), the sleep controller 5 determines the sleep process and the wake-up process to be performable. When the third period T₃ is shorter than the determination period Tj (T₂<Tj), the sleep controller 5 determines the sleep process and the wake-up process to be unperformable.

Now, there will be described an example of a method of calculating the determination period Tj based on retardation times of the wireless interface 1 and the main processor 4. Hereafter, a retardation time taken by the wireless interface 1 to make a transition from the wake-up state to the sleeping state will be denoted by Tdw₁, a retardation time taken by the wireless interface 1 to make a transition from the sleeping state to the wake-up state will be denoted by Tdw₂, a retardation time taken by the main processor 4 to make a transition from the wake-up state to the sleeping state is denoted by Tdm₁, and a retardation time taken by the main processor 4 to make a transition from the sleeping state to the wake-up state is denoted by Tdm₂. In the following description, β (≧0) is a margin that is set in advance. The margin β can be set to any value in conformity with an application or the like of the wireless communication device.

First, there will be described a method of calculating the determination period Tj in the case where the wake-up and the sleep of the wireless interface 1, and the wake-up and the sleep of the main processor 4 are performed in this order.

### (Case 1)

Case 1 is the case where the wireless interface 1 is in the wake-up state at the time of the determination, and the wireless interface 1 being in the wake-up state is necessary to execute the next task.

The case where the wireless interface 1 is in the wake-up state at the time of the determination corresponds to the case where a transmission task is executed immediately before the determination (YES in step S2), and to the case where a reception task is executed immediately before the determination (YES in step S4).

In addition, the case where the wireless interface 1 being in the wake-up state is necessary to execute the next task corresponds to the case where the next task is a transmission task or a reception task.

In Case 1, from the time at which the sleep controller 5 causes the main processor 4 to settle into sleep until the time at which the execution of the next task is started, a series of processes are performed: causing the main processor 4 to settle into sleep, causing the wireless interface 1 to settle into sleep, causing thereafter the main processor 4 to wake up, and causing the wireless interface 1 to wake up. Thus, in Case 1, the determination period Tj is calculated by the following formula.

[Expression 3]

Tj=Tdm₁+Tdw₁+Tdm₂+Tdw₂+β (3)

### Case (2)

Case 2 is the case where the wireless interface 1 is in the sleeping state at the time of the determination, and the wireless interface 1 being in the wake-up state is necessary to execute the next task.

The case where the wireless interface 1 is in the sleeping state at the time of the determination corresponds to the case where a sensor acquisition task is executed immediately before the determination (YES in step S6), and to the case where no task is executed immediately before the determination (NO in step S6).

In Case 2, from the time at which the sleep controller 5 causes the main processor 4 to settle into sleep until the time at which the execution of the next task is started, a series of processes are performed: causing the main processor 4 to settle into sleep, causing thereafter the main processor 4 to wake up, and causing the wireless interface 1 to wake up. Thus, in Case 2, the determination period Tj is calculated by the following formula.

[Expression 4]

Tj=Tdm₁+Tdm₂+Tdw₂+β (4)

### (Case 3)

Case 3 is the case where the wireless interface 1 is in the wake-up state at the time of the determination, and the wireless interface 1 being in the wake-up state is not necessary to execute the next task.

The case where the wireless interface 1 being in the wake-up state is not necessary to execute the next task corresponds to the case where the next task is a sensor acquisition task.

In Case 3, from the time at which the sleep controller 5 causes the main processor 4 to settle into sleep until the time at which the execution of the next task is started, a series of processes are performed: causing the wireless interface 1 to settle into sleep, causing the main processor 4 to settle into sleep, and causing the main processor 4 to wake up. Thus, in Case 3, the determination period Tj is calculated by the following formula.

[Expression 5]

Tj=Tdm₁+Tdw₁+Tdm₂+β (5)

### (Case 4)

Case 4 is the case where the wireless interface 1 is in the sleeping state at the time of the determination, and the wireless interface 1 being in the wake-up state is not necessary to execute the next task.

In Case 4, from the time at which the sleep controller 5 causes the main processor 4 to settle into sleep until the time at which the execution of the next task is started, a series of processes are performed: causing the main processor 4 to settle into sleep, and causing the main processor 4 to wake up. Thus, in Case 4, the determination period Tj is calculated by the following formula.

[Expression 6]

Tj=Tdm₁+Tdm₂+β (6)

Next, there will be described a method of calculating the determination period Tj in the case where the wake-up and the sleep of the wireless interface 1 is performed in parallel with the wake-up and the sleep of the main processor 4.

In this case, the sleep process of the wireless interface 1 is performed in parallel with the sleep process of the main processor 4. Note that the main processor 4 starts the sleep process after the main processor 4 inputs a sleep instruction into the wireless interface 1 and confirms that the wireless interface 1 have received the sleep instruction. Therefore, the sleep process of the main processor 4 is started later than the sleep process of the wireless interface 1.

Here, letting Td₁ be a retardation time period from the time at which the wireless interface 1 starts the sleep process until the time at which the main processor 4 starts the sleep process, and letting Tdmw₁ be a total delay time in the sleep processes of the wireless interface 1 and the main processor 4, when Tdw₁>Tdm₁+Td₁ is satisfied, Tdmw₁=Tdw₁ is satisfied. In addition, when Tdw₁≦Tdm₁+Td₁ is satisfied, Tdmw₁=Tdm₁+Td₁ is satisfied.

In addition, the wake-up process of the wireless interface 1 is performed in parallel with the wake-up process of the main processor 4. Note that the main processor 4 takes a predetermined time to become able to input a wake-up instruction into the wireless interface 1 from the time of starting the wake-up process of the main processor 4. Therefore, the wake-up process of the wireless interface 1 is started later than the wake-up process of the main processor 4.

Here, letting Td₂ be a retardation time from the time at which the main processor 4 starts the wake-up process until the time at which the wireless interface 1 starts the wake-up process, and letting Tdmw₂ be a total delay time in the wake-up processes of the wireless interface 1 and the main processor 4, when Tdm₂>Tdw₂+Td₂ is satisfied, Tdmw₂=Tdm₂ is satisfied. In addition, when Tdm₂≦Tdw₂+Td₂ is satisfied, Tdmw₂=Tdw₂+Td₂ is satisfied.

Using the total delay times Tdmw₁ and Tdmw₂, the determination periods Tj in Case 1 to Case 3, in the case where the sleep process and the wake-up process can be performed in parallel, are calculated by the following respective formulae.

[Expression 7]

Tj=Tdmw₁+Tdmw₂+β (7)

Tj=Tdm₁+Tdmw₂+β (8)

Td=Tdmw₁+Tdm₂+β (9)

Formula (7) represents the determination period Tj in Case 1, Formula (8) represents the determination period Tj in Case 2, and Formula (9) represents the determination period Tj in Case 3. In Case 4, since the sleep process and the wake-up process are not performed on the wireless interface 1, the determination period Tj is calculated by Formula (6).

Furthermore, there will be described a method of calculating the determination period Tj in the case where the main processor 4 is equipped with an operating system (OS), and this OS automatically determines whether the main processor 4 can perform the wake-up process and the sleep process, and performs the wake-up process and the sleep process if possible.

In this case, the sleep controller 5 may determine whether the wireless interface 1 can perform the sleep process and the wake-up process during the third period T₃. Therefore, the determination periods Tj in the above Case 1 to Case 4 are calculated by the following respective formulae.

[Expression 8]

Tj=Tdw₁+Tdw₂+β (10)

Tj=Tdw₂+β (11)

Tj−Tdw₁+β (12)

Tj=β (13)

Formula (10) represents the determination period Tj in Case 1, Formula (11) represents the determination period Tj in Case 2, Formula (12) represents the determination period Tj in Case 3, and Formula (13) represents the determination period Tj in Case 4.

Note that the method of calculating the determination period Tj is not limited to the above-described example. In addition, to simplify the calculation, a value common to Case 1 to Case 4 may be set in advance as the determination period Tj. For example, it is conceivable to set Tdm₁+Tdw₁+Tdm₂+Tdw₂ as the determination period Tj.

When the sleep process and the wake-up process are determined to be performable (YES in step S12), that is, when T₃≧Tj is satisfied, the sleep controller 5 sets the sleep period Ts based on the third period T₃ (step S13). The sleep period Ts is set so as to be shorter than the third period T₃ by the total delay times of the wake-up processes of the wireless interface 1 and the main processor 4 or longer. The sleep period Ts is set by, for example, the following formulae.

[Expression 9]

Ts=T₃−Tdm₂−Tdw₂−γ (14)

Ts=T₃−Tdm₂−γ (15)

Formula (14) represents the sleep period Ts in Case 1 and Case 2, and Formula (15) represents the sleep period Ts in Case 3 and Case 4. A value γ in Formula (14) and Formula (15) denotes a margin that is set in advance.

In Case 1 and Case 2, after a wake-up interrupt request is input into the main processor 4, the wake-up processes are performed on the wireless interface 1 and the main processor 4, and thus the retardation times Tdm₂ and Tdw₂ are subtracted from the third period T₃. In addition, in Case 3 and Case 4, after a wake-up interrupt request is input into the main processor 4, the wake-up process is performed only on the main processor 4, and thus the retardation time Tdm₂ is subtracted from the third period T₃.

Note that the method of setting the sleep period Ts is not limited to the above-described example. In addition, to simplify the calculation, a value to be subtracted from the third period T₃ may be set in advance. For example, it is conceivable to set Tdm₂+Tdw₂+γ as the value to be subtracted. In every case, the sleep period Ts is set to be shorter than the interrupt period Th.

Thereafter, the sleep controller 5 notifies the sleep period Ts to the setter 6 (step S14). The setter 6 having been notified the sleep period Ts sets a wake-up interrupt to output a wake-up interrupt request after a lapse of the sleep period Ts from the current time Tlocal. The interrupt time point Tint is set to be Tlocal+Ts.

In addition, the sleep controller 5 inputs the sleep instruction into the main processor 4. When the wireless interface 1 is sleeping, the main processor 4 immediately settles into sleep. On the other hand, when the wireless interface 1 has been woken up, the main processor 4 inputs a sleep instruction into the wireless interface 1 and thereafter settles into sleep. The wireless interface 1 and the main processor 4 thereby settle into sleep.

Note that the sleep controller 5 may notify a sleep period Ts, rather than a sleep instruction, to the main processor 4. The main processor 4 may recognize a sleep period Ts longer than zero (>0) as a sleep instruction.

From this point, the state where the wireless interface 1 and the main processor 4 sleep is kept during the sleep period Ts.

Thereafter, the sleep period Ts elapses (YES in step S15), that is, when the interrupt time point Tint comes, the setter 6 outputs the wake-up interrupt request. This wake-up interrupt request being input into the main processor 4 causes the main processor 4 to wake up (step S16). Thereafter, the processing of the flowchart returns to step S1.

Note that, in the case where a transmission task is executed in step S3, in the case where a reception task is executed in step S5, or in the case where a sensor task is executed in step S7, it is possible to implement transmission/reception and sensor data acquisition in a cyclic manner by updating the time point of each task in the execution in step 16.

On the other hand, when the sleep process and the wake-up process are determined to be unperformable (NO in step S12), that is, when T₃<Tj is satisfied, the sleep controller 5 terminates the processing of the flowchart, and the processing of the flowchart returns to step S1. At this point, the sleep controller 5 may not notify the sleep period Ts to the setter 6, may notify zero as the sleep period Ts to the setter 6, or may notify a termination notification to the setter 6. In addition, the sleep controller 5 may not input a sleep instruction into the main processor 4, may notify zero as the sleep period Ts to the main processor 4, or may notify a termination notification to the main processor 4.

By the sleep controller 5 notifying zero, as the sleep period Ts, or a termination notification to the setter 6 and the main processor 4, it is possible to explicitly terminate the processing performed by the sleep controller 5.

As described above, the wireless communication device in the present embodiment causes the wireless interface 1 and the main processor 4 to sleep during the sleep period Ts. It is thereby possible to reduce power consumption.

In addition, in a conventional wireless communication device, a sleep period is fixed, and thus it is not possible to cause the wireless interface 1 or the like to sleep during a period that is shorter than the fixed value of the sleep period.

In contrast to this, in the present embodiment, the sleep period Ts is calculated in accordance with the registration status of tasks of the device, and thus it is possible to cause the wireless interface 1 and the main processor 4 to sleep even during a short period. Therefore, it is possible to reduce power consumption more efficiently than a conventional wireless communication device. Taking the setting limitation of the sleep period due to the hardware into consideration, the wireless communication device in the present embodiment keeps its synchronization accuracy and makes it possible to sleep for a long period of time.

Furthermore, a conventional wireless communication device needs to include a clock that has an interrupt period longer than the fixed value of a sleep period, or a clock that has no constraint on interrupt period. However, such a clock has a complicated configuration, and thus it is expensive and becomes a cause of making circuit design difficult.

In contrast to this, in the present embodiment, the sleep period Ts shorter than the interrupt period Th is calculated by the sleep controller 5 and notified to the setter 6. For this reason, even when the setter 6 has a simple hardware configuration with a constraint on interrupt period Th, it is possible to cause the wireless interface 1 and the main processor 4 to settle into sleep, thereby reducing power consumption. Consequently, it is possible to make the circuit design of a wireless communication device easy, as well as to manufacture a wireless communication device at low cost.

Note that the wireless communication device in the present embodiment can be implemented by using a general-purpose computer device as basic hardware. That is, the wireless communication device can be implemented by causing a processor mounted on the above-described computer device to execute a program. At this point, the wireless communication device may be implemented by installing the above-described program on the computer device in advance, or may be implemented by storing the above-described program in a storage medium such as a CD-ROM in which or distributing the above-described program over a network and by installing the above-described program on the computer device as appropriate. In addition, the wireless communication device can be implemented by utilizing a memory, a hard disk, or a storage medium such as a CD-R, CD-RW, DVD-RAM, and DVD-R that is built in or externally mounted on the above computer device, as appropriate.

### Second Embodiment

A wireless communication device in a second embodiment will be described with reference to FIG. 4 to FIG. 6C. The first embodiment is described about the case where the execution timings of tasks are managed in terms of time points. In contrast to this, the present embodiment will be described about the case where the execution timings of tasks are managed in terms of slots. Note that the functional configuration and the hardware configuration of the wireless communication device in the present embodiment are the same as those in the first embodiment.

The description is first made about slots. The slots are more than one period that is set on a time axis and has a predetermined duration (e.g., 10 msec or 100 msec). The slots are set so as not to overlap with one another and to be consecutive on the time axis. Each slot has a duration, which is referred to as a slot length St.

Each slot is assigned a slot number. The slot numbers are assigned to the slots in ascending order or descending order of time. In addition, the slot numbers may be assigned to the slots uniquely or in a cyclic manner.

FIG. 4 is a diagram illustrating an example of a method of assigning the slot numbers. In the example illustrated in FIG. 4, the slot numbers are assigned to the slots in ascending order of time.

In an example on the upper side of FIG. 4, the slot numbers are assigned to the slots uniquely. That is, the slots are assigned with different slot numbers.

In an example on the lower side of FIG. 4, slot numbers 0 to n−1 are assigned to the slots in a cyclic manner. That is, the same slot number is assigned to a slot and a slot at the end of one cycle from the slot. By assigning the slot numbers in a cyclic manner in such a cyclic manner, it is possible to reduce a capacity that the main processor 4 is required to store the slot numbers. In addition, it is possible to simply manage tasks of a wireless communication device that operates in a cyclic manner.

For example, in the case of applying a wireless communication device to a sensor network, it is considered that the operation period of the wireless communication device is a long period. For example, in the case where an operation period is one minute, and the slot length St is 100 msec, one cycle includes 600 slots (one minute=600 slots×100 msec). To these 600 slots, for example, slot numbers 1 to 600 are assigned, and after the end of the 600 slots, the assigned slot numbers 1 to 600 are reset. Then, to 600 slots in the next cycle, the slot numbers 1 to 600 are assigned again. By repeating such assignment, slots included in an operation period of one minute can be easily managed with a small number of slot numbers. This is true for the case where the operation period is 30 minutes or 1 hour.

Note that it is assumed hereafter that slot numbers are assigned to slots in ascending order of time. In addition, a slot assigned a slot number X is referred to as a slot X. In this case, a slot next to the slot X is a slot X+1.

Next, a method of managing tasks in the present embodiment will be described. In the present embodiment, the execution timings of tasks are managed in terms of slot numbers, and the execution periods of the tasks are managed in terms of the number of slots.

For each task, the main processor 4 associates the task with the kind, the slot number X (execution timing), and the number of slots (execution period) of the task, and stores them therein in advance. Each task is started at the starting time point of a slot X and executed for a period equivalent to the number of slots, that is, for the number of slots×the slot length St. The main processor 4 stores the slot length St therein in advance.

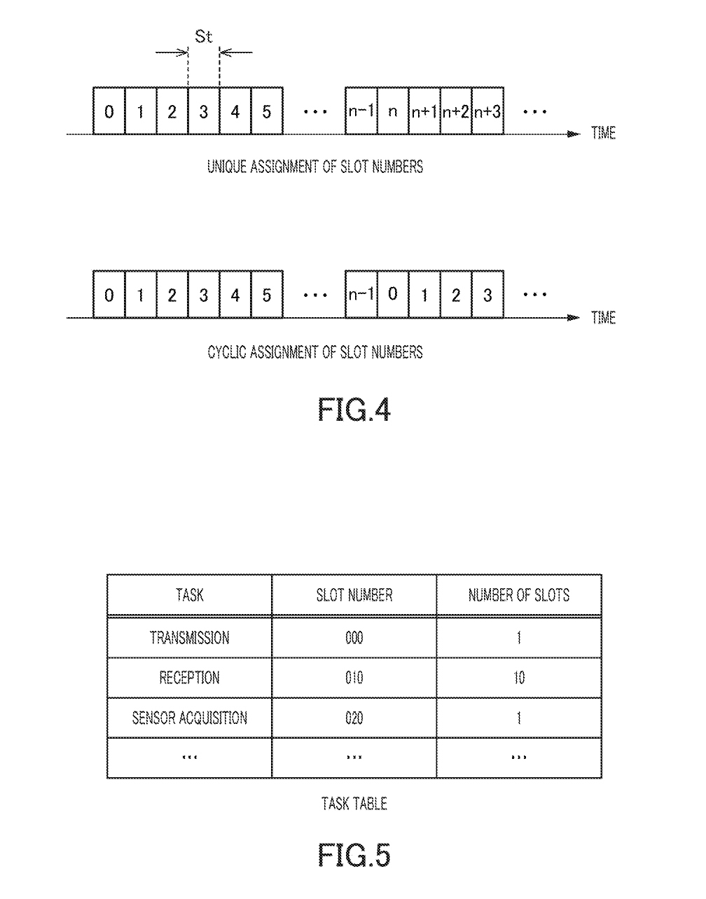

FIG. 5 is a diagram illustrating an example of a task table in the present embodiment. In the example illustrated in FIG. 5, each record corresponds to each task. Each record stores the kind, the slot number (execution timing), and the number of slots (execution period) of the task. For example, the record in the first row indicates a transmission task to be started at a starting time point a slot 000 and executed during one slot×the slot length St.

In addition, the main processor 4 counts up a current slot number NowSlot in the wake-up state. The current slot number NowSlot is a slot number of a slot NowSlot, which includes a current time. The main processor 4 can count up the current slot number NowSlot by incrementing the current slot number NowSlot by one every lapse of the slot length St.

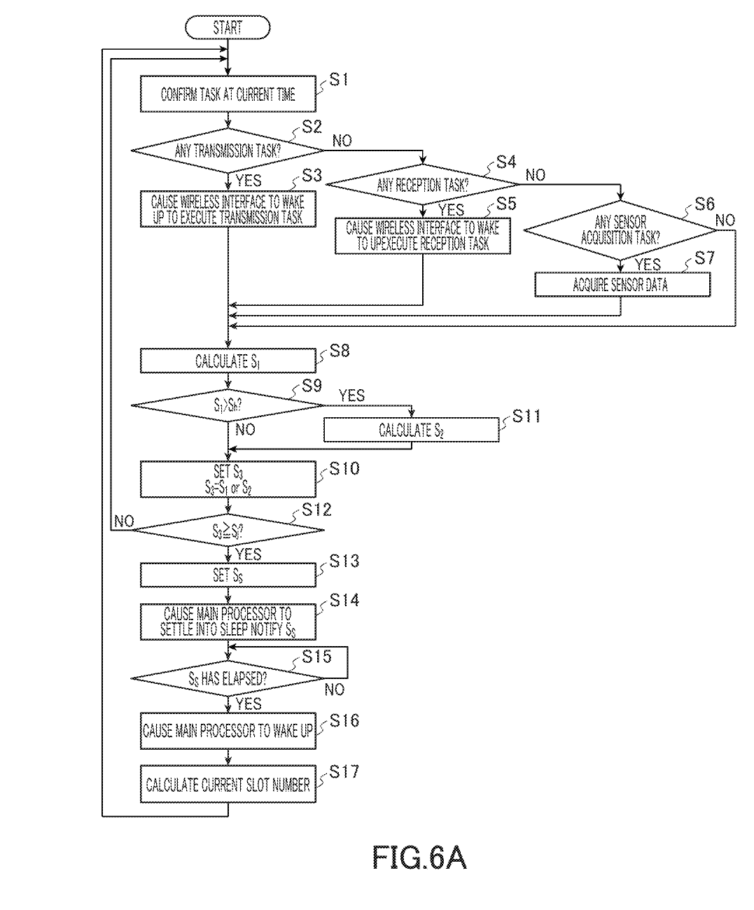

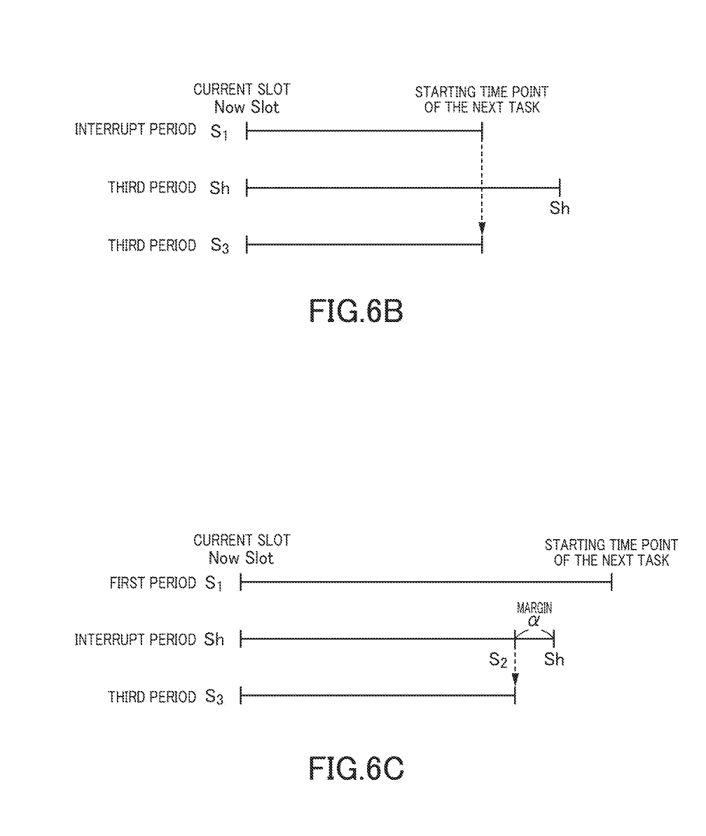

Next, the operation of the wireless communication device in the present embodiment will be described. FIG. 6A is a flowchart illustrating an example of the operation of the wireless communication device in the present embodiment. Steps Si to S16 in FIG. 6A correspond to steps S1 to S16 in FIG. 3A, respectively. The description will be made below focusing on points of difference from FIG. 3A.

First, the main processor 4 refers to the task table to confirm whether or not a task that needs to be executed at the current time Tlocal is present (step S1). Specifically, the main processor 4 compares the current slot number NowSlot with the slot number (execution timing) of each task. Then, the main processor 4 grasps a task having a slot number that matches the current slot number NowSlot as a task to be executed at the current time Tlocal.

After that, steps S2 to S7 are the same as those of FIG. 3A. That is, when a transmission task, a reception task, or a sensor acquisition task is present as a task to be executed at the current time Tlocal, the main processor 4 executes the task for the execution period of the task. Note that, in the present embodiment, the execution period is the number of slots×the slot length St, as previously described. Then, after the execution of a task, or when there is no task to be executed at the current time Tlocal, the processing of the flowchart proceeds to step S8.

In step S8, the sleep controller 5 calculates a first period S₁. The first period S₁ is the number of slots equivalent to the first period T₁, being represented by S₁=T₁/St. The sleep controller 5 acquires, from the main control unit 4, slot number at which each task stored in the task table are started and calculates the first period S₁ by the following formula.

[Expression 10]

S₁=min(Slot[k]−NowSlot) (16)

In Formula (16), a Slot[k] is a slot number of a slot at which each task is started. An index k is a number that is assigned to each task having a slot number after the current slot number NowSlot (Time[k]>NowSlot). When the total number of the tasks stored in the task table is N, 0≦k<N is satisfied.

Next, the sleep controller 5 compares the first period S₁ with an interrupt period Sh (step S9). The interrupt period Sh is the number of slots equivalent to the interrupt period Th, being represented by Sh=Th/St. When the first period S₁ is equal to or shorter than the interrupt period Sh (S₁≦Sh) (NO in step S9), the sleep controller 5 sets the first period S₁ to a third period S₃ (step S10). That is, S₃=S₁≦Sh is satisfied. A magnitude relationship among the first period S₁, the interrupt period Sh and the third period S₃ is shown in FIG. 6B.

On the other hand, when the first period S₁ is longer than the interrupt period Sh (S₁>Sh) (YES in step S9), the sleep controller 5 calculates a second period S₂ based on the interrupt period Sh (step S11). The second period S₂ is the number of slots equivalent to the second period T₂, being represented by S₂=T₂/St. The second period S₂ is calculated by, for example, the following formula.

[Expression 11]

S₂=Sh−α (17)

In the present embodiment, the margin α is the number of slots. Subtracting the margin α from the interrupt period Sh makes the second period S₂ equal to or shorter than the interrupt period Sh. Thereafter, the sleep controller 5 sets the second period S₂ to the third period S₃ (step S10). That is, S₃=S₂≦Sh is satisfied. A magnitude relationship among the first period S₁, the interrupt period Sh, the second period S₂ and the third period S₃ is shown in FIG. 6C.

As seen from the above description, in the wireless communication device in the present embodiment, the third period S₃ is set to be equal to or shorter than the interrupt period Sh in every case.

Subsequently, the sleep controller 5 determines whether or not the sleep process and the wake-up process can be performed on the wireless interface 1 and the main processor 4 during the third period S₃. To this end, the sleep controller 5 first refers to the task table to grasp the kind of the next task. Next, the sleep controller 5 calculates a determination period Sj based on a current operation state of the wireless interface 1 and the kind of the next task. The determination period Sj is the number of slots equivalent to the determination period Tj, being represented by Sj=Tj/St.

Then, the sleep controller 5 compares the third period S₃ with the determination period Sj (step S12). When the third period S₃ is equal to or longer than the determination period Sj (S₃≧Sj), the sleep controller 5 determines the sleep process and the wake-up process to be performable. When the third period S₃ is shorter than the determination period Sj (S₃<Sj), the sleep controller 5 determines the sleep process and the wake-up process to be unperformable.

Now, there will be described an example of a method of calculating the determination period Sj based on the retardation times Tdm₁, Tdw₁, Tdm₂, and Tdw₂ of the wireless interface 1 and the main processor 4. The following Case 1 to Case 4 are the same as those in the first embodiment.

First, there will be described a method of calculating the determination period Sj in the case where the wake-up and the sleep of the wireless interface 1, and the wake-up and the sleep of the main processor 4 are performed in this order.

The determination periods Sj in the above Case 1 to Case 4 are calculated by the following respective formulae.

[Expression 12]

Sj=(Tdm₁+Tdw₁+Tdm₂+Tdw₂+β)/St (18)

Sj=(Tdm₁+Tdm₂+Tdw₂+β)/St (19)

Sj=(Tdm₁+Tdw₁+Tdm₂+β)/St (20)

Sj=(Tdm₁+Tdm₂+β)/St (21)

Formula (18) represents the determination period Sj in Case 1, Formula (19) represents the determination period Sj in Case 2, Formula (20) represents the determination period Sj in Case 3, and Formula (21) represents the determination period Sj in Case 4. In Formula (18) to Formula (21), a margin β represents a time but may represent the number of slots. When the margin β represents the number of slots, the determination periods Sj in Case 1 to Case 4 are calculated by the following respective formulae.

[Expression 13]

Sj=(Tdm₁+Tdw₁+Tdm₂+Tdw₂)/St+β (22)

Sj=(Tdm₁+Tdm₂+Tdw₂)/St+β (23)

Sj=(Tdm₁+Tdw₁+Tdw₂)/St+β (24)

Sj=(Tdm₁+Tdm₂)/St+β (25)

Formula (22) to Formula (25) corresponds to Formula (18) to Formula (21), respectively. That is, Formula (22) represents the determination period Sj in Case 1, Formula (23) represents the determination period Sj in Case 2, Formula (24) represents the determination period Sj in Case 3, and Formula (25) represents the determination period Sj in Case 4.

Next, there will be described a method of calculating the determination period Sj in the case where the wake-up and the sleep of the wireless interface 1 is performed in parallel with the wake-up and the sleep of the main processor 4.

Using the total delay times Tdmw₁ and Tdmw₂, the determination periods Tj in Case 1 to Case 3, in the case where the sleep process and the wake-up process can be performed in parallel, are calculated by the following respective formulae.

[Expression 14]

Sj=(Tdmw₁+Tdmw₂β)/St (26)

Sj=(Tdm₁+Tdmw₂+β)/St (27)

Sj=(Tdmw₁+Tdm₂+β)/St (28)

Sj=(Tdmw₁+Tdmw₂)/St+β (29)

Sj=(Tdm₁+Tdmw₂)/St+β (30)

Sj=(Tdmw₁+Tdm₂)/St+β (31)

Formula (26) to Formula (28) represent the determination periods Sj in Case 1 to Case 3, respectively, in the case where the margin β represents a time. Formula (29) to Formula (31) represent the determination periods Sj in Case 1 to Case 3, respectively, in the case where the margin β represents the number of slots.

Furthermore, there will be described a method of calculating the determination period Sj in the case where the main processor 4 is equipped with an operating system (OS), and this OS automatically determines whether the main processor 4 can perform the wake-up process and the sleep process, and performs the wake-up process and the sleep process if possible.

In this case, the sleep controller 5 may determine whether the wireless interface 1 can perform the sleep process and the wake-up process during the third period S₃. Therefore, the determination periods Sj in the above Case 1 to Case 4 are calculated by the following respective formulae.

[Expression 15]

Sj=(Tdw₁+Tdw₂+β)/St (32)

Sj=(Tdw₂+β)/St (33)

Sj=(Tdw₁+β)/St (34)

Sj=β/St (35)

Sj=(Tdw₁+Tdw₂)/St+β (36)

Sj=Tdw₁/St+β (37)

Sj=Tdw₂/St+β (38)

Sj=β (39)

Formula (32) to Formula (35) represent the determination periods Sj in Case 1 to Case 4, respectively, in the case where the margin β represents a time. Formula (36) to Formula (39) represent the determination periods Sj in Case 1 to Case 4, respectively, in the case where the margin β represents the number of slots.

Note that the method of calculating the determination period Sj is not limited to the above-described example. In addition, to simplify the calculation, a value common to Case 1 to Case 4 may be set in advance as the determination period Sj. For example, it is conceivable to set (Tdm₁+Tdw₁+Tdm₂+Tdw₂/St) as the determination period Sj.

When the sleep process and the wake-up process are determined to be performable (YES in step S12), that is, when S₃≧Sj is satisfied, the sleep controller 5 sets the sleep period Ss based on the third period S₃ (step S13). The sleep period Ss is the number of slots equivalent to the sleep period Ts, being represented by Ss=Ts/St. The sleep period Ss is set so as to be shorter than the third period S₃ by the total delay times of the wake-up processes of the wireless interface 1 and the main processor 4 or longer. The sleep period Ss is set by, for example, the following formulae.

[Expression 16]

Ss=S₃−(Tdm₂+Tdw₂+γ)/St (40)

Ss=S₃−(Tdm₂+γ)/St (41)

Ss=S₃−(Tdm₂+Tdw₂)/St−γ (42)

Ss=S₃−Tdm₂/St−γ (43)

Formula (40) and Formula (41) represent the sleep periods Ss in Case 1 and Case 2, respectively, in the case where the margin γ represents a time. Formula (42) and Formula (43) represent the sleep periods Ss in Case 1 and Case 2, respectively, in the case where the margin γ represents the number of slots.

In Case 1 and Case 2, after a wake-up interrupt request is input into the main processor 4, the wake-up processes are performed on the wireless interface 1 and the main processor 4, and thus the number of slots equivalent to the retardation times Tdm₂ and Tdw₂ are subtracted from the third period S₃. In addition, in Case 3 and Case 4, after a wake-up interrupt request is input into the main processor 4, the wake-up process is performed only on the main processor 4, and thus the number of slots equivalent to the retardation time Tdm₂ is subtracted from the third period S₃.

Note that the method of setting the sleep period Ss is not limited to the above-described example. In addition, to simplify the calculation, a value to be subtracted from the third period S₃ may be set in advance. For example, it is conceivable to set (Tdm₂+Tdw₂+γ)/St as the value to be subtracted. In every case, the sleep period Ss is set to be shorter than the interrupt period Sh.

Thereafter, the sleep controller 5 notifies the sleep period Ss to the setter 6 (step S14). The setter 6 having been notified the sleep period Ss sets a wake-up interrupt to output a wake-up interrupt request after a lapse of the sleep period Ss from the current slot NowSlot. The interrupt time point Tint is set to be the starting time point of a slot (NowSlot+Ss+1). Note that the sleep controller 5 may notify a time period equivalent to the sleep period Ss, namely, the sleep period Ts. The sleep period Ts is represented by Ts=Ss×St.

In addition, the sleep controller 5 inputs the sleep instruction into the main processor 4. When the wireless interface 1 is sleeping, the main processor 4 immediately settles into sleep. On the other hand, when the wireless interface 1 has been woken up, the main processor 4 inputs a sleep instruction into the wireless interface 1 and thereafter settles into sleep. The wireless interface 1 and the main processor 4 thereby settle into sleep.

Note that the sleep controller 5 may notify a sleep period Ss, rather than a sleep instruction, to the main processor 4. The main processor 4 may recognize a sleep period Ss longer than zero (>0) as a sleep instruction.

From this point, the state where the wireless interface 1 and the main processor 4 sleep is kept during the sleep period Ss.

Thereafter, the sleep period Ss elapses (YES in step S15), that is, when the interrupt time point Tint comes, the setter 6 outputs the wake-up interrupt request. This wake-up interrupt request being input into the main processor 4 causes the main processor 4 to wake up (step S16).

In the present embodiment, the main processor 4 calculates a current slot number after waking up (step S17). This is because the main processor 4 cannot count the current slot number in the sleeping state. The current slot number can be calculated by adding the sleep period Ss to a slot number at the time of sleeping. Thereafter, the processing of the flowchart returns to step S1. Note that the main processor 4 may calculate a slot number at the time of waking up before sleeping.

On the other hand, when the sleep process and the wake-up process is determined to be unperformable (NO in step S12), that is, when S₃<Sj is satisfied, the sleep controller 5 terminates the processing of the flowchart, and the processing of the flowchart returns to step S1. At this point, the sleep controller 5 may not notify the sleep period Ss to the setter 6, may notify zero as the sleep period Ss to the setter 6, or may notify a termination notification to the setter 6. In addition, the sleep controller 5 may not input a sleep instruction into the main processor 4, may notify zero as the sleep period Ss to the main processor 4, or may notify a termination notification to the main processor 4.

By the sleep controller 5 notifying zero, as the sleep period Ss, or a termination notification to the setter 6 and the main processor 4, it is possible to explicitly terminate the processing performed by the sleep controller 5.

As described above, the wireless communication device can operate as in the first embodiment even in the case the execution timings and the execution periods of tasks are managed in terms of slots. Therefore, also in the present embodiment, it is possible to implement a wireless communication device that has a simple hardware configuration and is low power-consuming, as in the first embodiment.

Note that the above-description is made, by way of example, about the case where the wireless communication device performs all of the processing based on the number of slots. However, the wireless communication device in the present embodiment can also perform part of the processing based on time.

### Third Embodiment

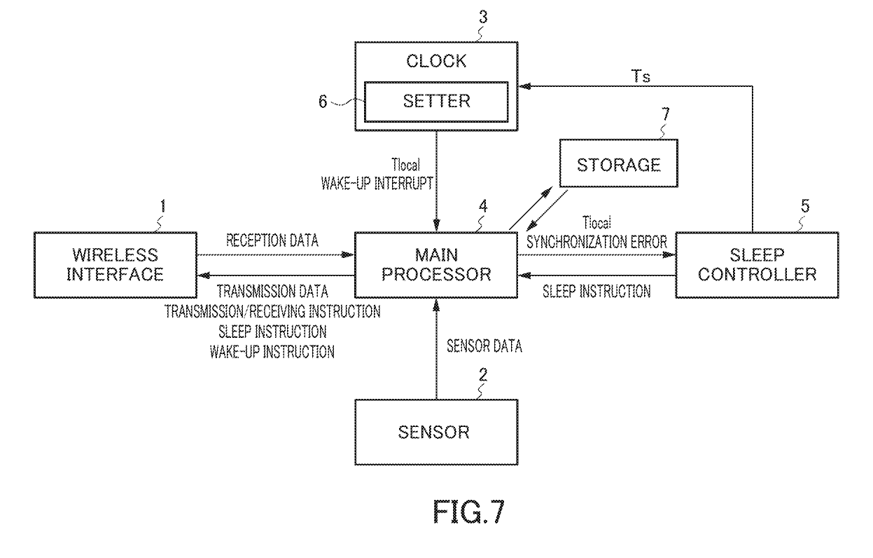

A wireless communication device in a third embodiment will be described with reference to FIG. 7 to FIG. 9. In the present embodiment, there will be described a wireless communication device that corrects the sleep period Ts in accordance with a synchronization error with another wireless communication device.

FIG. 7 is a diagram illustrating an example of a functional configuration of the wireless communication device in the present embodiment. In the wireless communication device illustrated in FIG. 7, the main processor 4 inputs a synchronization error into the sleep controller 5. The other functional configuration and hardware configuration of the wireless communication device in the present embodiment are the same as those in the first embodiment.

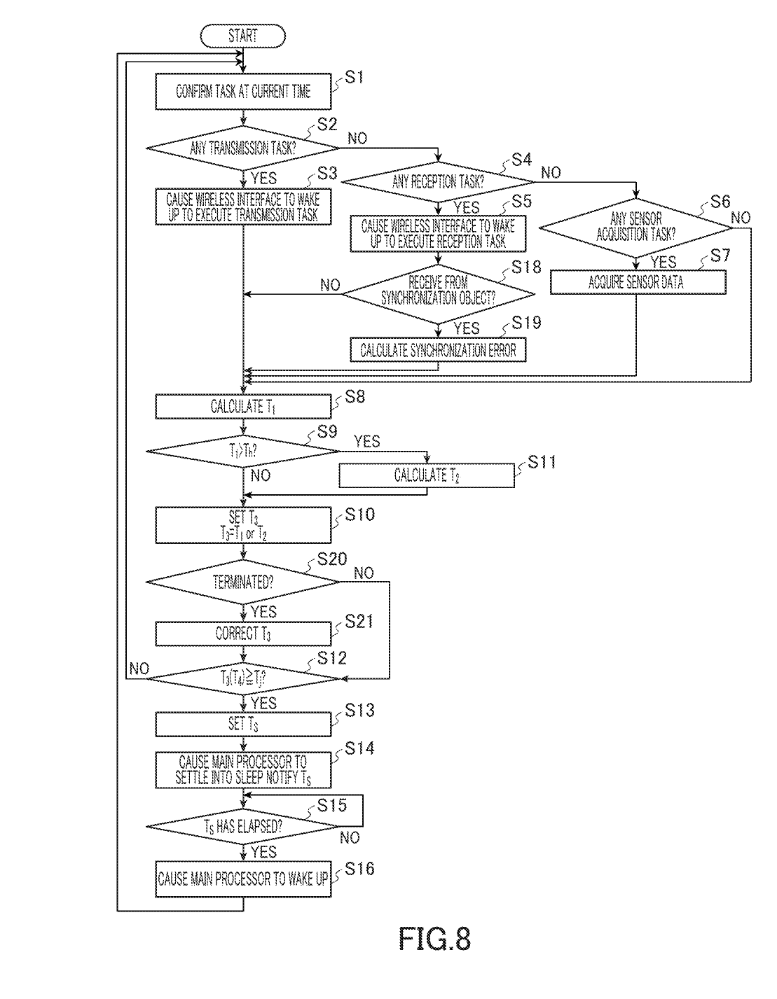

FIG. 8 is a flowchart illustrating an example of the operation of the wireless communication device in the present embodiment. Steps S1 to S16 in FIG. 8 correspond to steps S1 to S16 in FIG. 3A, respectively. The description will be made below focusing on points of difference from FIG. 1.

In the present embodiment, when there is a reception task that needs to be executed at the current time Tlocal (YES in step S4), the main processor 4 executes the reception task (step S5) and determines whether or not reception data has been received from a synchronization object during the execution of the reception task (step S18). The synchronization object is another wireless communication device to be an object with which the wireless communication device synchronizes a time. The synchronization object is, for example, a parent node in a mesh or tree network, or a destination node in a star network. The main processor 4 refers to the identifier of a transmission source contained in each item of the reception data that has been received, which makes it possible to determine whether or not the reception data is reception data from the synchronization object.

When no reception data has been received from the synchronization object (NO in step 18), the processing of the flowchart proceeds to step S8.

On the other hand, when reception data has been received from the synchronization object (YES in step 18), the main processor 4 calculates a synchronization error Td with the synchronization object (step S19). The synchronization error Td is a difference between a current time counted by the device and a current time counted by the synchronization object. The synchronization error Td is calculated by, for example, the following formula.

[Expression 17]

Td=Tlocal−(Tsend+Tdelay) (44)

In Formula (44), Tsend denotes the transmission time point of the reception data, and Tdelay denotes a retardation time relating to transmission/reception. The transmission time point Tsend is contained in the reception data. In addition, the retardation time Tdelay is prepared in advance in the form of a table or the like and stored in the main processor 4.

Note that the method of calculating the synchronization error Td is not limited to Formula (44).

In general, a synchronization error contains a clock error and an error attributable to a jitter component. The clock error is an error that is attributable to an error between the frequency of the clock 3 of the wireless communication device and the frequency of a clock of the synchronization object. In addition, the error attributable to a jitter component is an error that is attributable to a deviation between initial values of the clocks.

The main processor 4 may include a filter to correct these kinds of errors. By correcting the above-described errors with the filter, the main processor 4 can calculate the synchronization error Td with high accuracy. Consequently, the sleep controller 5 can correct the synchronization error Td with high accuracy.

In addition, in the case where items of reception data are received from a plurality of synchronization objects, the main processor 4 may calculate, as the synchronization error Td, the average value, median, weighted average value, or the like of the synchronization errors that are calculated for the synchronization objects.

The main processor 4 inputs the synchronization error Td calculated in such a manner into the sleep controller 5. Thereafter, the processing of the flowchart proceeds to step S8. From this point, the processes of steps S8 to S10 are the same as those in the first embodiment.

Note that the processes of step S18 and step S19 may be performed collectively on all the items of reception data that are received after the execution of the reception task or may be performed whenever an item of reception data is received during the execution of the reception task.

After setting the third period T₃ in step S10, the sleep controller 5 determines whether or not the operation period has been terminated (step S20). Specifically, the sleep controller 5 determines whether or not the reception task to receive reception data from the synchronization object, which is set in a cyclic manner, has been terminated.

When the operation period has not been terminated (NO in step S20), the processing of the flowchart proceeds to step 512. From this point, the processes of steps S12 to S16 are the same as those in the first embodiment.

On the other hand, the operation period has been terminated (YES in step S20), the sleep controller 5 corrects the third period T₃ based on the synchronization error Td (step S21). As a result, the sleep period Ts is corrected based on the synchronization error Td. The corrected third period T₃ is referred to as a fourth period T₄. The fourth period T₄ corresponds to the third period T₃ that is corrected such that the synchronization error Td becomes zero.

The fourth period T₄ is calculated by, for example, the following formula.

[Expression 18]

T₄=T₃−Td (45)

When the current time Tlocal of the device is earlier than the current time of the synchronization object, the synchronization error Td becomes a positive value. Therefore, by subtracting the synchronization error Td from the third period T₃, the third period T₃ can be made shorter by the synchronization error Td that makes the current time Tlocal of the device earlier than the current time of the synchronization object.

Similarly, when the current time Tlocal of the device is later than the current time of the synchronization object, the synchronization error Td becomes a negative value. Therefore, by subtracting the synchronization error Td from the third period T₃, the third period T₃ can be longer by the synchronization error Td that makes the current time Tlocal of the device later than the current time of the synchronization object.

From this point, the processes of steps S12 to S16 are performed using the fourth period T₄ instead of the third period T₃. That is, the sleep controller 5 compares the fourth period T₄ with the determination period Tj to determine whether or not the sleep process and the wake-up process are performable (step S12). When the sleep process and the wake-up process are performable (YES in step S12), the sleep period Ts is set based on the fourth period T₄ (step S13). The sleep period Ts may be set by replacing T₃ in Formula (14) and Formula (15) with T₄. From this point, the processes of steps S14 to S16 are the same as those in the first embodiment.

As described above, according to the present embodiment, it is possible to correct the synchronization error Td between the wireless communication device and the synchronization object. This enables the synchronization between the operation of the wireless communication device and the operation of the synchronization object.

In addition, the correction of the synchronization error Td is performed only once in one operation period, and thus it is possible to keep a high synchronization accuracy with little throughput.

Note that, in the present embodiment, it is preferable to set the margin α to be not less than a maximum value up to which the synchronization error Td can take on. This enables the fourth period T₄ to be set to be the interrupt period Th or shorter even when the synchronization error Td is corrected.

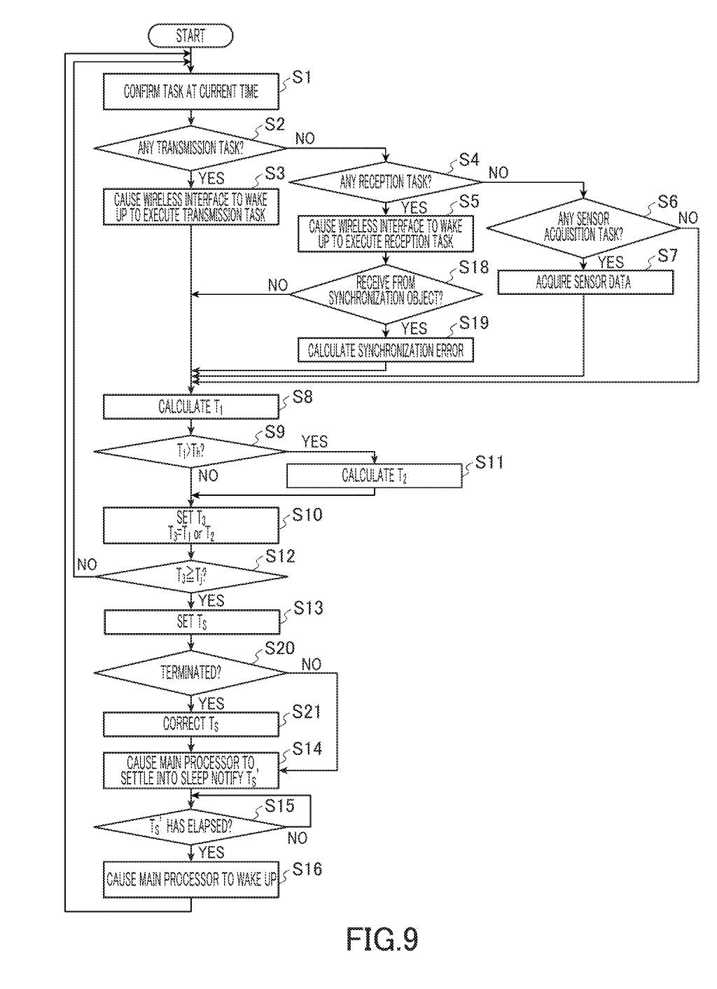

Here, FIG. 9 is a flowchart illustrating another example of the operation of the wireless communication device in the present embodiment. In the present embodiment, as illustrated in FIG. 9, the processes of steps S20 and S21 may be performed after the calculation of the sleep period Ts.

In this case, in step S21, the sleep controller 5 corrects the sleep period Ts based on the synchronization error Td. The corrected sleep period Ts is referred to as a sleep period Ts′. The sleep period Ts′ corresponds to the sleep period Ts that is corrected such that the synchronization error Td becomes zero. The sleep period Ts′ is calculated by, for example, the following formula.

[Expression 19]

Ts′=Ts−Td (46)

Thereafter, the sleep controller 5 notifies the sleep period Ts′ to the setter 6. Even in such operation, it is possible to correct, as in the above, the synchronization error Td between the wireless communication device and the synchronization object to synchronize the operation of the wireless communication device with the operation of the synchronization object.

### Fourth Embodiment

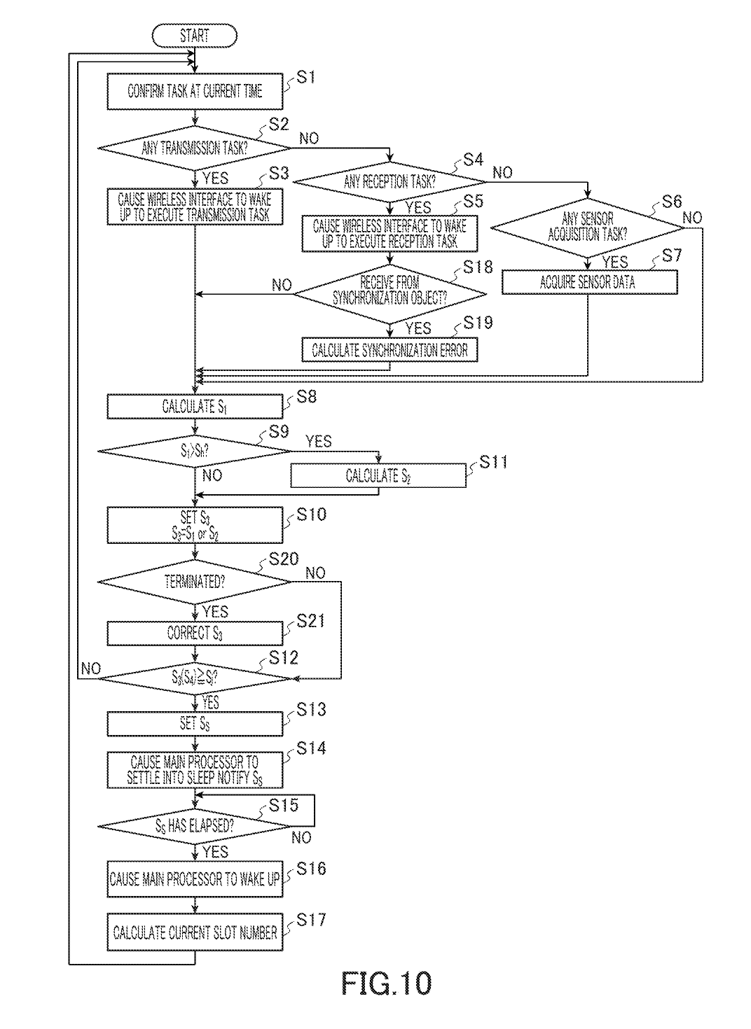

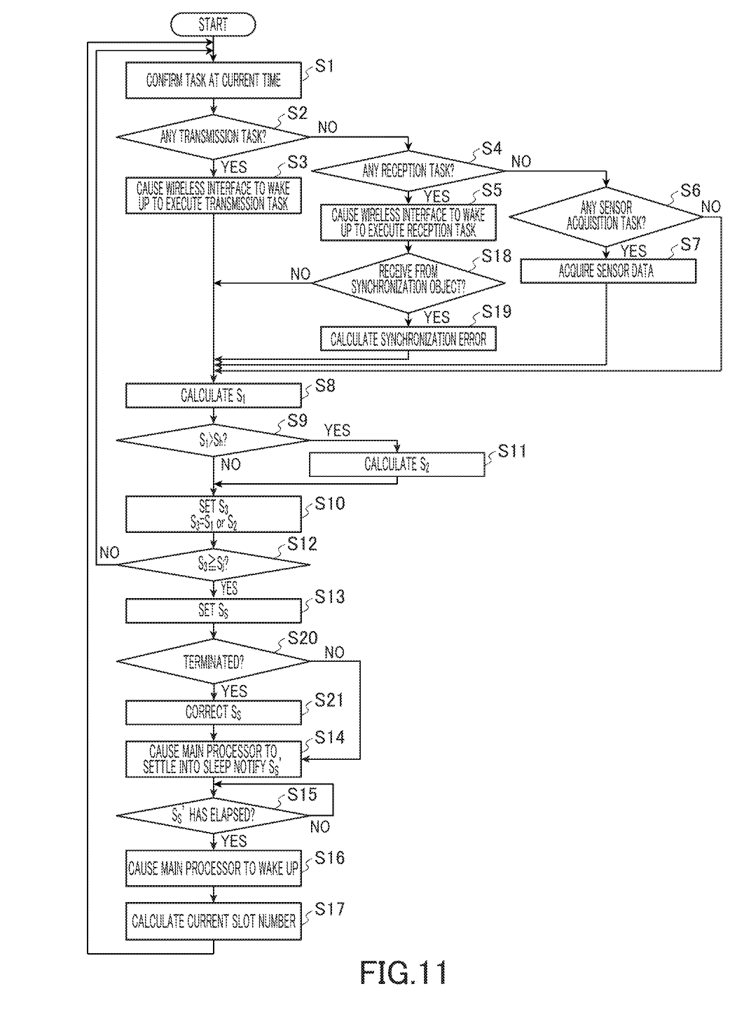

A wireless communication device in a fourth embodiment will be described with reference to FIG. 10 and FIG. 11. In the present embodiment, there will be described a wireless communication device that corrects the sleep period Ss in accordance with a synchronization error with another wireless communication device. Note that the functional configuration and the hardware configuration of the wireless communication device in the present embodiment are the same as those in the third embodiment.

FIG. 10 is a flowchart illustrating an example of the operation of the wireless communication device in the present embodiment. Steps S1 to S17 in FIG. 10 correspond to steps S1 to S17 in FIG. 6A, respectively. The description will be made below focusing on points of difference from FIG. 6A.

In the present embodiment, when there is a reception task that needs to be executed at the current time Tlocal (YES in step S4), the main processor 4 executes the reception task (step S5) and determines whether or not reception data has been received from a synchronization object during the execution of the reception task (step S18). When no reception data has been received from the synchronization object (NO in step 18), the processing of the flowchart proceeds to step S8.

On the other hand, when reception data has been received from the synchronization object (YES in step 18), the main processor 4 calculates a synchronization error Sd with the synchronization object (step S19). The synchronization error Sd is the number of slots equivalent to the synchronization error Td, being represented by Sd=Td/St. The synchronization error Sd is calculated by, for example, the following formula.

[Expression 20]

Sd={Tlocal−(Tsend+Tdelay)}/St (47)

Note that the method of calculating the synchronization error Sd is not limited to Formula (47). The main processor 4 may include a filter to correct at least one of the clock error and the error attributable to a jitter component. By correcting the above-described errors with the filter, the main processor 4 can calculate the synchronization error Sd with high accuracy. Consequently, the sleep controller 5 can correct the synchronization error Sd with high accuracy.

In addition, in the case where items of reception data are received from a plurality of synchronization objects, the main processor 4 may calculate, as the synchronization error Sd, the average value, median, weighted average value, or the like of the synchronization errors that are calculated for the synchronization objects.

The main processor 4 inputs the synchronization error Sd calculated in such a manner into the sleep controller 5. Thereafter, the processing of the flowchart proceeds to step S8. From this point, the processes of steps S8 to S10 are the same as those in the second embodiment.

Note that the processes of step S18 and step S19 may be performed collectively on all the items of reception data that are received after the execution of the reception task or may be performed whenever an item of reception data is received during the execution of the reception task.

After setting the third period S₃ in step S10, the sleep controller 5 determines whether or not the operation period has been terminated (step S20). Specifically, the sleep controller 5 determines whether or not the reception task to receive reception data from the synchronization object, which is set in a cyclic manner, has been terminated.

When the operation period has not been terminated (NO in step S20), the processing of the flowchart proceeds to step S12. From this point, the processes of steps S12 to S17 are the same as those in the second embodiment.

On the other hand, the operation period has been terminated (YES in step S20), the sleep controller 5 corrects the third period S₃ based on the synchronization error Sd (step S21). The corrected third period S₃ is referred to as a fourth period S₄. The fourth period S₄ is the number of slots equivalent to the fourth period T₄, being represented by S₄=T₄/St. The fourth period S₄ is calculated by, for example, the following formula.

[Expression 21]

S₄=S₃−Sd (48)

When the current time Tlocal of the device is earlier than the current time of the synchronization object, the synchronization error Sd becomes a positive value. Therefore, by subtracting the synchronization error Sd from the third period S₃, the third period S₃ is made shorter by the synchronization error Sd that makes the current time Tlocal of the device earlier than the current time of the synchronization object.

Similarly, when the current time Tlocal of the device is later than the current time of the synchronization object, the synchronization error Sd becomes a negative value. Therefore, by subtracting the synchronization error Sd from the third period S₃, the third period S₃ can be longer by the synchronization error Sd that makes the current time Tlocal of the device later than the current time of the synchronization object.

From this point, the processes of steps S12 to S17 are performed using the fourth period S₄ instead of the third period S₃. That is, the sleep controller 5 compares the fourth period S₄ with the determination period Sj to determine whether or not the sleep process and the wake-up process are performable (step S12). When the sleep process and the wake-up process are performable (YES in step S12), the sleep period Ss is set based on the fourth period S₄ (step S13). The sleep period Ss may be set by replacing S₃ in Formula (40) to Formula (43) with S₄. From this point, the processes of steps S14 to S17 are the same as those in the second embodiment.

As described above, the wireless communication device can operate as in the third embodiment even in the case the execution timings and the execution periods of tasks are managed in terms of slots. Therefore, also in the present embodiment, it is possible to correct, as in the third embodiment, the synchronization error Sd between the wireless communication device and the synchronization object to synchronize the operation of the wireless communication device with the operation of the synchronization object.

Note that, in the present embodiment, it is preferable to set the margin α to be not less than a maximum value up to which the synchronization error Sd can take on. This enables the fourth period S₄ to be set to be the interrupt period Sh or shorter even when the synchronization error Sd is corrected.

Here, FIG. 11 is a flowchart illustrating another example of the operation of the wireless communication device in the present embodiment. In the present embodiment, as illustrated in FIG. 11, the processes of steps S20 and S21 may be performed after the calculation of the sleep period Ss.

In this case, in step S21, the sleep controller 5 corrects the sleep period Ss based on the synchronization error Sd. The corrected sleep period Ss is referred to as a sleep period Ss′. The sleep period Ss′ is the number of slots equivalent to the sleep period Ts′, being represented by Ss′=Ts′/St. The sleep period Ss′ is calculated by, for example, the following formula.

[Expression 22]

Ss′=Ss−St (49)

Thereafter, the sleep controller 5 notifies the sleep period Ss′ to the setter 6. Even in such operation, it is possible to correct, as in the above, the synchronization error Sd between the wireless communication device and the synchronization object to synchronize the operation of the wireless communication device with the operation of the synchronization object.

Note that the above-description is made, by way of example, about the case where the wireless communication device performs all of the processing based on the number of slots. However, the wireless communication device in the present embodiment can also perform part of the processing based on time.

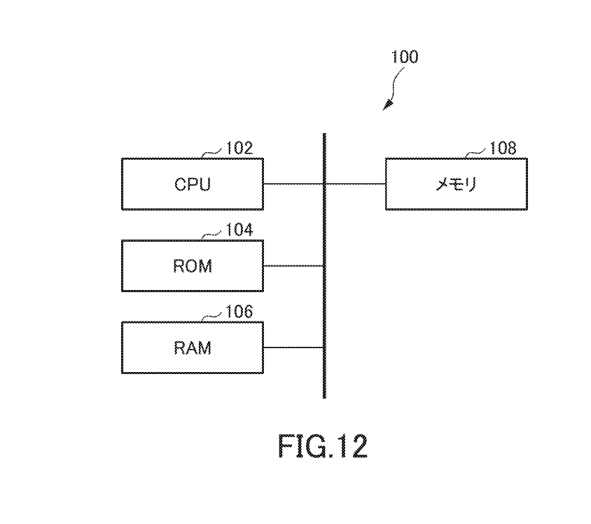

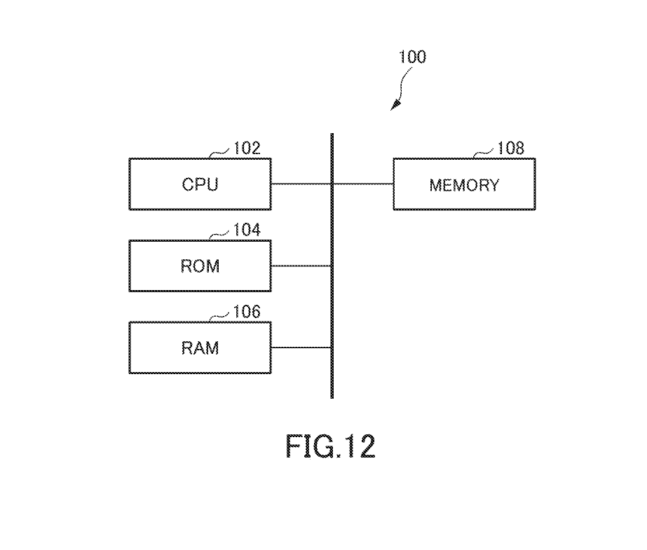

Incidentally, as shown in FIG. 12, in the embodiments mentioned above, the main processor 4 and the sleep controller 5 may be constituted by, for example, a CPU (Central Processing Unit) 102, a ROM (Read Only Memory) 104 and a RAM (Random Access Memory) 106 in a microcomputer. Further, the main processor 4 and the sleep controller 5 may be included in one unit of the CPU, the ROM and the RAM, or in different units of the CPU, the ROM and the RAM. Moreover, the microcomputer may include a memory 108 in addition to, for example, at least one of the CPU 102, the ROM 104 and the RAM 106. The memory 108 is a storage device like a hard disk, a flash memory and so on, and various programs and data to operate the main processor 4 and the sleep controller 5 are stored.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
an interface configured to transmit and receive a wireless signal; and
a sleep controller configured to set a sleep period equal to or shorter than a predetermined interrupt period when a first period from a current time to a start timing of a next one of tasks is longer than the interrupt period.

2. The wireless communication device according to claim 1, wherein the sleep controller calculates the sleep period shorter than the first period based on the first period when the first period is equal to or shorter than the interrupt period.

3. The wireless communication device according to claim 1, further comprising a setter configured to wake up the interface after the sleep period equal to or shorter than the interrupt period has passed.

4. The wireless communication device according to claim 1, further comprising a main processor configured to control a transmission and a receipt of the wireless signal in the interface, and
wherein the main processor also sleeps for a period equal to or shorter than interrupt period.

5. The wireless communication device according to claim 4, wherein the main processor controls the start timing of the transmission and the receipt of the wireless signal based on time or slots.

6. The wireless communication device according to claim 4, wherein the sleep period is shorter than the first period, and
a difference between the first period and the sleep period is equal to or longer than a sum of periods for which the interface and the main processor are changed from a sleeping state to a wake-up state.

7. The wireless communication device according to claim 4, wherein, when the interface is in the wake-up state at a current time, a difference between the first period and the sleep period is equal to or longer than a sum of a transition period for which the interface is changed from a wake-up state to a sleeping state, a transition period for which the interface is changed from a sleeping state to a wake-up state, and a transition period for which the main processor is changed from a sleeping state to a wake-up state.

8. The wireless communication device according to claim 4, wherein, when the wireless signal is received from a synchronization object, the main processor calculates a synchronization error with the synchronization object, and
the sleep controller corrects the sleep period based on the synchronization error.

9. A wireless communication system, comprising a plurality of the wireless communication devices according to claim 1, the wireless communication devices transmitting and receiving the wireless signal each other.
